(19) United States
(12) Patent Application Publication
(10) Pub. No.: US 2024/0406531 A1
(43) Pub. Date: Dec. 5, 2024

(54) EARBUD MOUNTED CAMERA

(71) Applicant: Sony Group Corporation, Tokyo (JP)

(72) Inventor: Brant Candelore, Poway, CA (US)

(73) Assignee: Sony Group Corporation, Tokyo (JP)

(21) Appl. No.: 18/203,583

(22) Filed: May 30, 2023

(51) Int. Cl. H04N 23/50; G06T 7/70; G06V 20/52; G06V 40/10; G10L 13/027; H04R 1/10

(52) U.S. Cl. CPC H04N 23/555; G06T 7/70; G06V 20/52; G06V 40/10; G10L 13/027; H04R 1/1016; H04R 1/1041

(57) ABSTRACT

Implementations generally relate to an earbud mounted camera. In some implementations, a method includes capturing, by one or more cameras coupled to one or more earbuds, images of an environment of the user while the user is wearing the one or more earbuds. The method further includes converting data associated with the images to audio. The method further includes providing, by the one or more earbuds, the audio to the user.

### BACKGROUND

Earbuds have become commonplace and even stylish to wear. For example, people have started to wear earbuds all the time at home, at work, around town, etc. Conventional earbuds typically function to provide users with private enjoyment of listening to music or podcasts, listening to audiobooks, listening on a phone call, etc.

### SUMMARY

Implementations generally relate to an earbud mounted camera. In some implementations, a system includes one or more earbuds configured to be inserted into one or more ears of a user, and one or more cameras coupled to the one or more earbuds. The system also includes one or more processors, and includes logic encoded in one or more non-transitory computer-readable storage media for execution by the one or more processors. When executed, the logic is operable to cause the one or more processors to perform operations including: capturing, by the one or more cameras, images of an environment of the user while the user is wearing the one or more earbuds; converting data associated with the images to audio; and providing, by the one or more earbuds, the audio to the user.

With further regard to the system, in some implementations, the one or more earbuds include a central body and one or more posts, where one or more lenses of the one or more cameras are coupled to the central body or the one or more posts of the one or more earbuds. In some implementations, the logic when executed is further operable to cause the one or more processors to perform operations including: identifying at least one object in the images; accessing a memory that stores data associated with the at least one object; converting at least one portion of the data to audio; and providing, by the one or more earbuds, the at least one portion of the data to the user. In some implementations, the logic when executed is further operable to cause the one or more processors to perform operations including: identifying at least one object in the images, where the at least one object is a person; accessing a memory that stores data associated with the person; converting at least one portion of the data to audio; and providing, by the one or more earbuds, the at least one portion of the data to the user, where the at least one portion of the data includes at least a name of the person. In some implementations, the logic when executed is further operable to cause the one or more processors to perform operations including: identifying at least one object in the images; computing a location of at least one object; converting data associated with an identification and a location of the at least one object to audio; and providing, by the one or more earbuds, the identification and the location of the at least one object to a user. In some implementations, the logic when executed is further operable to cause the one or more processors to perform operations including identifying at least one object in the images, where the at least one object is a health hazard. In some implementations, the logic when executed is further operable to cause the one or more processors to perform operations including identifying at least one object in the images, where the at least one object is currency.

In some implementations, a non-transitory computer-readable storage medium with program instructions thereon is provided. When executed by one or more processors, the instructions are operable to cause the one or more processors to perform operations including: capturing, by one or more cameras coupled to one or more earbuds, images of an environment of a user while the user is wearing the one or more earbuds; converting data associated with the images to audio; and providing, by the one or more earbuds, the audio to the user.

With further regard to the computer-readable storage medium, in some implementations, the one or more earbuds include a central body and one or more posts, where one or more lenses of the one or more cameras are coupled to the central body or the one or more posts of the one or more earbuds. In some implementations, the instructions when executed are further operable to cause the one or more processors to perform operations including: identifying at least one object in the images; accessing a memory that stores data associated with the at least one object; converting at least one portion of the data to audio; and providing, by the one or more earbuds, the at least one portion of the data to the user. In some implementations, the instructions when executed are further operable to cause the one or more processors to perform operations including: identifying at least one object in the images, where the at least one object is a person; accessing a memory that stores data associated with the person; converting at least one portion of the data to audio; and providing, by the one or more earbuds, the at least one portion of the data to the user, where the at least one portion of the data includes at least a name of the person. In some implementations, the instructions when executed are further operable to cause the one or more processors to perform operations including: identifying at least one object in the images; computing a location of at least one object; converting data associated with an identification and a location of the at least one object to audio; and providing, by the one or more earbuds, the identification and the location of the at least one object to a user. In some implementations, the instructions when executed are further operable to cause the one or more processors to perform operations including identifying at least one object in the images, where the at least one object is a health hazard. In some implementations, the instructions when executed are further operable to cause the one or more processors to perform operations including identifying at least one object in the images, where the at least one object is currency.

In some implementations, a method includes: capturing, by one or more cameras coupled to one or more earbuds, images of an environment of a user while the user is wearing the one or more earbuds; converting data associated with the images to audio; and providing, by the one or more earbuds, the audio to the user.

With further regard to the method, in some implementations, the one or more earbuds include a central body and one or more posts, where one or more lenses of the one or more cameras are coupled to the central body or the one or more posts of the one or more earbuds. In some implementations, the method further includes: identifying at least one object in the images; accessing a memory that stores data associated with the at least one object; converting at least one portion of the data to audio; and providing, by the one or more earbuds, the at least one portion of the data to the user. In some implementations, the method further includes: identifying at least one object in the images, where the at least one object is a person; accessing a memory that stores data associated with the person; converting at least one portion of the data to audio; and providing, by the one or more earbuds, the at least one portion of the data to the user, where the at least one portion of the data includes at least a name of the person. In some implementations, the method further includes: identifying at least one object in the images; computing a location of at least one object; converting data associated with an identification and a location of the at least one object to audio; and providing, by the one or more earbuds, the identification and the location of the at least one object to a user. In some implementations, the method further includes identifying at least one object in the images, where the at least one object is a health hazard.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of a user wearing an earbud in an ear, according to some implementations.

FIG. 2 is a close-up diagram of an earbud inserted in the ear of the user, where earbud includes an earbud mounted camera at the end of the post, according to some implementations.

FIG. 3 is a close-up diagram of an earbud inserted in the ear of the user, where earbud includes an earbud mounted camera at the bottom of the central body, according to some implementations.

FIG. 4 is a close-up diagram of an earbud inserted in the ear of the user, where earbud includes an earbud mounted camera at the front of the central body, according to some implementations.

FIG. 5 is an example flow diagram for implementing one or more earbud mounted cameras, according to some implementations.

FIG. 6 is a block diagram of an example network environment, which may be used for some implementations described herein.

FIG. 7 is a block diagram of an example computer system, which may be used for some implementations described herein.

### DETAILED DESCRIPTION

Implementations described herein provide an earbud mounted camera. As described in more detail herein, implementations extend the functionality of an earbud to include a camera, image processing, audio processing, as well as assistance to users. For example, implementations may assist users who may be visually and/or mentally impaired by recognizing particular objects such as people, hazards, etc., and by providing relevant information about such objections such as identifying information, location information, etc. to users. Implementations utilize image recognition techniques to recognize objects captured by the camera. Implementations also provide audio information to users in a private manner. For example, the system may remind the user of the name of a person standing in front of the user without the person knowing.

Conventionally, visual systems have been mounted on various types of glasses. However, if a user does not need glasses to correct vision, the user typically would not want to wear glasses. Also, glasses with cameras typically require special frames, and there is a limited number of glass frame styles available. Often times, glasses may include circuitry such as a computer platform, etc., and are consequently bigger and bulkier, which might not be stylish. Implementations described herein address these shortcomings of glasses, and provide other value functionality that are not provided by glasses.

As described in more detail herein, in various implementations, a system captures, by one or more cameras coupled to one or more earbuds, images of an environment of the user while the user is wearing the one or more earbuds. The system then converts data associated with the images to audio. The system then provides, by the one or more earbuds, the audio to the user. Various example implementations directed to these features are described in more detail herein.

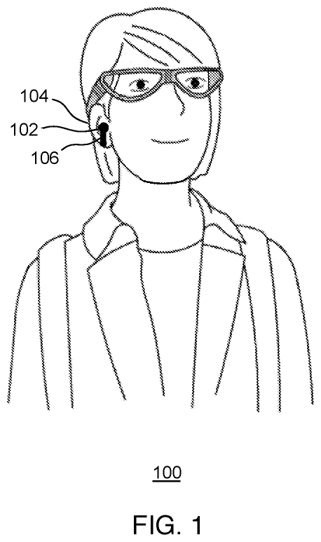

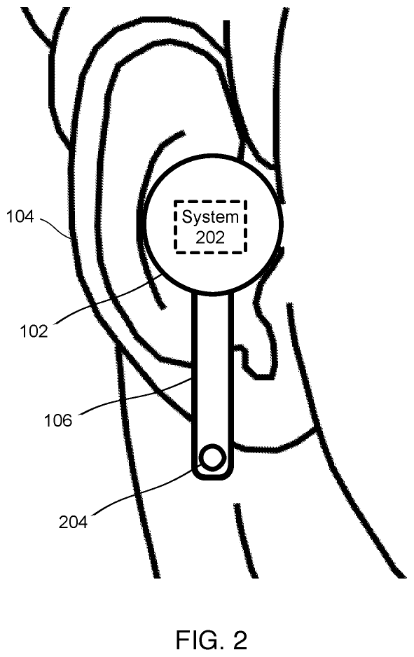

FIG. 1 is a block diagram of a user 100 wearing an earbud 102 in an ear 104, according to some implementations. As shown, earbud 102 has a post 106 coupled thereto. Post 106 may contain components such as a rechargeable battery, wiring, etc. Either the body of earbud 102 and/or post 106 may also contain an imaging chip for processing images captured by a camera (shown in FIG. 2). Implementations described herein may be applied to a single earbud such as earbud 102 in the right ear of user 100. These implementations may apply to a second earbud (not shown) such as one in the left ear of the user. Further implementations directed to operations of earbud 102 and/or a second earbud are described in more detail herein, including in FIG. 2, for example.

FIGS. 2, 3, and 4 are close-up diagrams of implementations of different configurations of earbuds inserted in ear 104 of the user. For example, FIG. 2 is a close-up diagram of earbud 102 inserted in ear 104 of the user, where earbud 102 includes an earbud mounted camera at the end of post 106, according to some implementations. In various implementations, earbud 102 includes a system 202 and a camera 204. In various implementations, a lens and aperture of camera 204 may be tiny and innocuous such as those on a smartphone. System 202 controls operations of earbud 106 and camera 204 to perform implementations described herein.

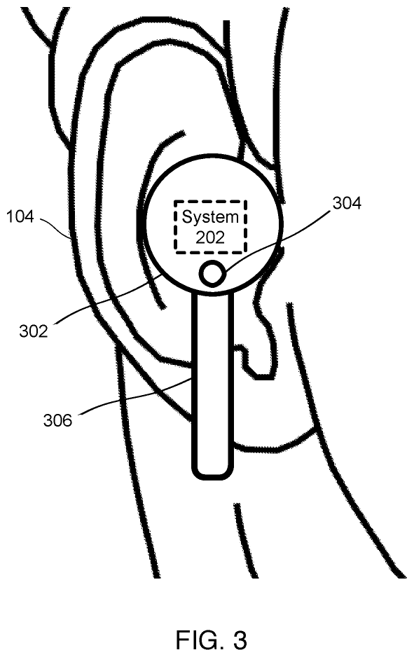

The position of the earbud mounted camera may vary, depending on the particular implementation. For example, as shown above in FIG. 2, camera 204 is mounted on earbud post 106. FIG. 3 is a close-up diagram of an earbud 302 inserted in ear 104 of the user, where earbud 302 includes an earbud mounted camera 304 at the bottom of the central body, according to some implementations. As shown, there is no camera at the end of post 306. Instead, earbud 302 is configured such that camera 304 is positioned at the bottom of the central body.

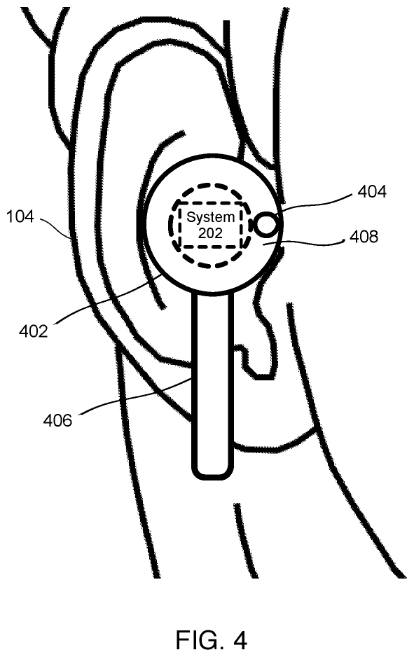

FIG. 4 is a close-up diagram of an earbud 402 inserted in ear 104 of the user, where earbud 402 includes an earbud mounted camera 404 at the front of the central body, according to some implementations.

In various implementations, post 406 may rotate to enable various orientations of camera 404 such as pointing to the side, straight back, straight forward as shown, etc. In an example implementation, camera 404 may be positioned on a wheel 408 that rotates relative to post 406. This enables the user to rotate and position camera 404 as desired. As shown, camera 404 is mounted on the side of an earbud 102 which protrudes from ear 104. The position of camera 404 may make the orientation be forward or slightly to the side of the user, etc. In some implementations, camera. In some implementations, earbud 402 may not have a post, such as with a hearing aid that corrects for hearing loss.

The various implementations described herein may apply to a single earbud and corresponding earbud mounted camera, such as earbud 102 and camera 204 and/or may apply to a second earbud and corresponding earbud mounted camera (not shown). For example, a user may wear such an earbud mounted camera system configured to be inserted in the right ear and/or left ear of a user. If there are multiple earbuds (e.g., two earbuds), system 202 of earbud 102 communicates with a corresponding system of the other earbud such that they synchronize in order to provide media content sounds to the user and/or other audio via speakers (not shown) associated with the earbuds.

As shown, in various implementations, one or more of the earbuds each include a central body and one or more posts, such as post 106 of earbud 102. Also, one or more lenses of the one or more cameras coupled to the central body or the one or more posts of the one or more earbuds, such as the lens of camera 204 of earbud 102.

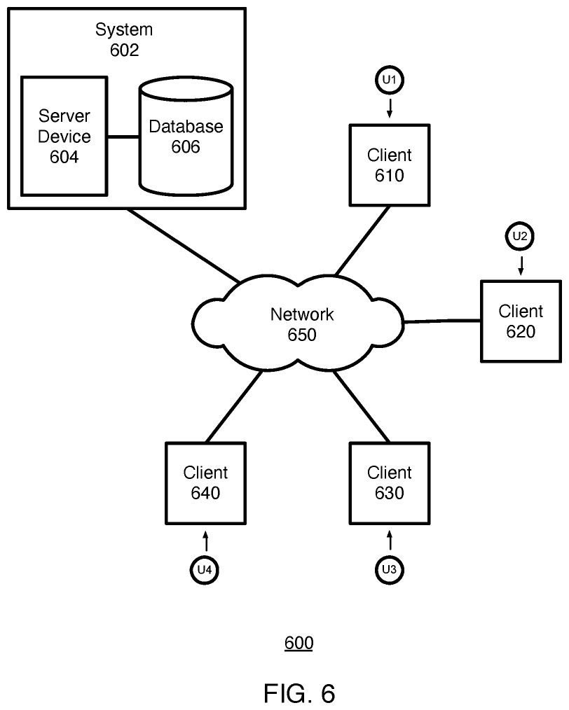

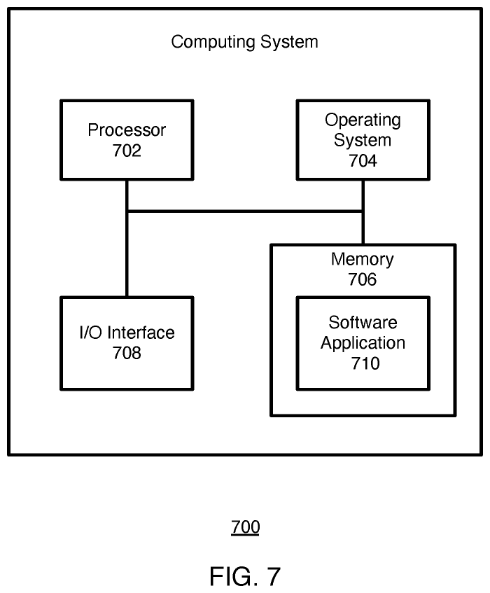

As described in more detail herein, camera 204 captures images of the environment of the user while the user is wearing earbud 102. System 202 converts data associated with the images to audio. Earbud 102 of system 202 provides the audio to the user. For example, in an example implementation, system 202 may identify a person in the environment of the user. The system accesses a memory that stores data associated with the person, and converts at least one portion of the data to audio. Database 606 of FIG. 6 or memory 606 of FIG. 7 may be used to implement the memory. The one or more earbuds of the system then provides at least one portion of the data to the user. That portion may include, for example, the name of the person, the relationship between the person and the user, and any other information about the person that the user may want know, etc.

In another example implementation, system 202 may identify at least one object in the images, such as a bench, fire hydrant, etc. System 202 computes a location of at least one object. In various implementations, system 202 may compute the location of the object relative to the user. For example, system 202 may determine that the object is located directly in front of the user and becoming closer as the user walks toward the object. System 202 then converts data associated with the identification, and the location of the object to audio. The one or more earbuds of the system then privately provides the identification (e.g., bench, fire hydrant, etc.) and the location (e.g., directly in front of the user and becoming closer, etc.) of the object to a user. Further implementations directed to these features are described in more detail herein.

For ease of illustration, FIGS. 2, 3, and 4 show one block for each of system 202 and cameras 204, 304, and 404. These blocks 202, 204, 304, and 404 may represent multiple systems and cameras. For example, there may be two or more cameras associated with earbud 102, where different cameras capture images and/or video of the environment in multiple directions (e.g., front, side, rear directions, etc.). In another example, a camera that is remote to and associated with earbud 102 may also capture images and/or video of the environment of the user. Such a remote camera may be one that is standalone and positioned in the vicinity (e.g., in a room, in a vehicle, etc.), or may be integrated with another client device such as a smartphone. In other implementations, the overall system may not have all of the components shown and/or may have other elements including other types of elements instead of, or in addition to, those shown herein.

While system 202 performs implementations described herein, in other implementations, any suitable component or combination of components associated with system 202 or any suitable processor or processors associated with system 202 may facilitate performing the implementations described herein. For example, system 202 may be integrated into one or more of the earbuds. While each earbud may include its own integrated system, two systems of two earbuds synchronize in order to provide media content to the user. Also, either of the two systems of the two earbuds share images and/or video to be converted and processed to provide audio data to the user. In various implementations, there may be a master system such as system 202 and a slave system such as the system of the other earbud, or vice versa.

While system 202 is shown as being integrated with earbud 102, in other implementations, system 202 may represent a master system that is remote to the earbud 102. For example, in some implementations, system 202 may be integrated into a smartphone (not shown) or integrated into another client device that communicates with the one or more earbuds. In various implementations, system 202 may be in the cloud and may communicate with the one or more earbuds via a smartphone or other client device. For ease of illustration, system 202 shown may represent any of these example system implementations.

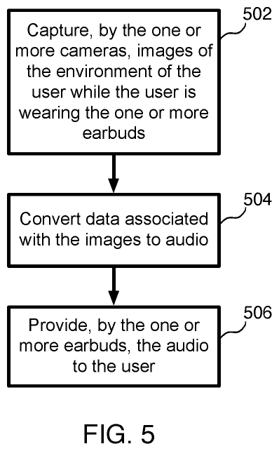

FIG. 5 is an example flow diagram for implementing one or more earbud mounted cameras, according to some implementations. Referring to both FIGS. 2 to 5, a method is initiated at block 502, where a system such as system 202 captures, by the one or more cameras such as camera 204, images of the environment of the user while the user is wearing the one or more earbuds such as earbud 102. In various implementations, system 202 utilizing multiple cameras enables depth perception, which may allow for better image recognition. For visually impaired users, multiple cameras enable vision on both sides of the user in order to more accurately identify obstacles or hazards, etc.

At block 504, system 202 converts data associated with the images to audio. As indicated herein, in some implementations, system 202 may process images and/or video to convert data associated with such images to audio in the implementation where system 202 is integrated with earbud 102. In some implementations, system 202 may be remote to earbud 102 and/or may operating in combination with another system such as a system that is integrated with a smartphone or other client device. As such, system 202 may process images or video locally to earbud 102 and/or may sent images or video to an application such as an application on a smartphone and/or over the internet for image recognition. In some implementations, system 202 may represent a server in the cloud, such as system 602 of FIG. 6.

In various implementations, the system may after recognize a give object (e.g., a person, an inanimate object, etc. access relevant information from memory. Such relevant information may include, for example, identifying information, etc. In various implementations, the system may compute the location one or more objects using global positioning system (GPS) techniques and/or other triangulation techniques. The system converts such data associated with the images to audio.

At block 506, system 202 system provides, by the one or more earbuds, the audio to the user. For example, the system may deliver the following example messages to the user. “Shelly is standing in front of you.” “Shelly is your daughter.” “There is a boulder in front of you.” “The boulder is getting closer to you.” “The boulder is a tripping hazard.”

The following are example use cases. In various implementations, the system identifies at least one object in the images. As indicated herein, the object may be a person or an inanimate object. The system accesses a memory that stores data associated with the at least one object. The system then converts at least one portion of the data to audio. The system provides, by the one or more earbuds, the at least one portion of the data to the user, as described in the examples herein.

In various implementations, the system identifies at least one object in the images, where the at least one object is a person. The person may be a recognized loved one, friend, etc. whom the user may know. The system accessing a memory that stores data associated with the person. The stored data may include the name of the recognized person, and any other information that may be relevant to the user. Such other information may include, for example, their relations (e.g., child, friend, coworker, etc.). The system then converts at least one portion of the data to audio. The system then provides, by the one or more earbuds, the at least one portion of the data to the user, where the at least one portion of the data includes at least a name of the person. This may be especially helpful for users who may be visually impaired and/or memory impaired and who may need assistance in remember particular people who are present, and reminders of other information that would be relevant to the user.

In various implementations, identifies at least one object in the images. The system the computes a location of at least one object. The object may be a person as in the previous example. The object may also be an inanimate object such as a rock, a piece of furniture such as a table or benches, a car, etc. The system then converts data associated with an identification and a location of the at least one object to audio. The system then provides, by the one or more earbuds, the identification and the location of the at least one object to a user. For example, the system may indicate that the object is in front of the user, approaching the user if the user is walking toward the object, or to the side of the user, etc.

In various implementations, the system identifies at least one object in the images, where the at least one object is a health hazard. This may especially helpful for users who may be vision impaired and who may need warnings as to hazards such as tripping hazards.

Implementations described herein have numerous other applications. For example, in some implementations, the system may verbally alert user that the camera is smudged or if the camera function is not enabled. In various implementations, the system identifies at least one object in the images, where the at least one object is currency. The object may be any other object that has written language on it. Implementations described herein are especially helpful for users who may be vision impaired and who may need assistance in reading information on objects such as currency, letters, or reading material (e.g., books, magazines, newspapers, etc.). In some implementations, the system may also capture images and/or video in order to track what the user is doing. For example, the system may function as a life event recorder and summarize a given day for the user.

In some implementations, the system may operate with another application such as one on a smartphone to provide the user with additional relevant information. For example, the system may determine based on footage of the surroundings that the user needs to go to another location. For example, the user may be upstairs in a house or facility but needs to be downstairs. The system may direct the user to go to a particular target location, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, the system informs a user of any relevant objects, including people, hazardous tripping hazards, etc. Implementations described herein are especially helpful for users who may be memory impaired and who may need assistance in remember particular people who are present. Implementations described herein are also especially helpful for users who may be vision impaired and who may need warnings as to hazards such as tripping hazards, or who may need assistance in reading information on objects such as currency.

FIG. 6 is a block diagram of an example network environment 600, which may be used for some implementations described herein. In some implementations, network environment 600 includes a system 602, which includes a server device 604 and a database 606. For example, system 602 may be used to implement system 202 of FIG. 2, as well as to perform implementations described herein. Network environment 600 also includes client devices 610, 620, 630, and 640, which may communicate with system 602 and/or may communicate with each other directly or via system 602.

Any of client devices 610, 620, 630, and 640 may represent earbuds with earbud mounted cameras, stand-alone cameras, mobile devices such as smartphones that have systems that may assist system 202 of FIGS. 2, 3, and 4, and/or system 602 of FIG. 6. Network environment 600 also includes a network 650 through which system 602 and client devices 610, 620, 630, and 640 communicate. Network 650 may be any suitable communication network such as a Wi-Fi network, Bluetooth network, the Internet, etc.

For ease of illustration, FIG. 6 shows one block for each of system 602, server device 604, and network database 606, and shows four blocks for client devices 610, 620, 630, and 640. Blocks 602, 604, and 606 may represent multiple systems, server devices, and network databases. Also, there may be any number of client devices. In other implementations, environment 600 may not have all of the components shown and/or may have other elements including other types of elements instead of, or in addition to, those shown herein.

While server device 604 of system 602 performs implementations described herein, in other implementations, any suitable component or combination of components associated with system 602 or any suitable processor or processors associated with system 602 may facilitate performing the implementations described herein.

In the various implementations described herein, a processor of system 602 and/or a processor of any client device 610, 620, 630, and 640 cause the elements described herein (e.g., information, etc.) to be displayed in a user interface on one or more display screens.

FIG. 7 is a block diagram of an example computer system 700, which may be used for some implementations described herein. For example, computer system 700 may be used to implement server device 604 of FIG. 6 and/or system 202 of FIG. 2, as well as to perform implementations described herein. In some implementations, computer system 700 may include a processor 702, an operating system 704, a memory 706, and an input/output (I/O) interface 708. In various implementations, processor 702 may be used to implement various functions and features described herein, as well as to perform the method implementations described herein. While processor 702 is described as performing implementations described herein, any suitable component or combination of components of computer system 700 or any suitable processor or processors associated with computer system 700 or any suitable system may perform the steps described. Implementations described herein may be carried out on a user device, on a server, or a combination of both.

Computer system 700 also includes a software application 710, which may be stored on memory 706 or on any other suitable storage location or computer-readable medium. Software application 710 provides instructions that enable processor 702 to perform the implementations described herein and other functions. Software application may also include an engine such as a network engine for performing various functions associated with one or more networks and network communications. The components of computer system 700 may be implemented by one or more processors or any combination of hardware devices, as well as any combination of hardware, software, firmware, etc.

For ease of illustration, FIG. 7 shows one block for each of processor 702, operating system 704, memory 706, I/O interface 708, and software application 710. These blocks 702, 704, 706, 708, and 710 may represent multiple processors, operating systems, memories, I/O interfaces, and software applications. In various implementations, computer system 700 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more earbuds configured to be inserted into one or more ears of a user;
one or more cameras coupled to the one or more earbuds;
one or more processors coupled to the one or more earbuds; and
logic encoded in one or more non-transitory computer-readable storage media for execution by the one or more processors and when executed operable to cause the one or more processors to perform operations comprising:
capturing, by the one or more cameras, images of an environment of the user while the user is wearing the one or more earbuds;
converting data associated with the images to audio; and
providing, by the one or more earbuds, the audio to the user.

2. The system of claim 1, wherein the one or more earbuds comprise a central body and one or more posts, and wherein one or more lenses of the one or more cameras are coupled to the central body or the one or more posts of the one or more earbuds.

3. The system of claim 1, wherein the logic when executed is further operable to cause the one or more processors to perform operations comprising:
identifying at least one object in the images;
accessing a memory that stores data associated with the at least one object;
converting at least one portion of the data to audio; and
providing, by the one or more earbuds, the at least one portion of the data to the user.

4. The system of claim 1, wherein the logic when executed is further operable to cause the one or more processors to perform operations comprising:
identifying at least one object in the images, wherein the at least one object is a person;
accessing a memory that stores data associated with the person;
converting at least one portion of the data to audio; and
providing, by the one or more earbuds, the at least one portion of the data to the user, wherein the at least one portion of the data comprises at least a name of the person.

5. The system of claim 1, wherein the logic when executed is further operable to cause the one or more processors to perform operations comprising:
identifying at least one object in the images;
computing a location of at least one object;
converting data associated with an identification and a location of the at least one object to audio; and
providing, by the one or more earbuds, the identification and the location of the at least one object to a user.

6. The system of claim 1, wherein the logic when executed is further operable to cause the one or more processors to perform operations comprising identifying at least one object in the images, wherein the at least one object is a health hazard.

7. The system of claim 1, wherein the logic when executed is further operable to cause the one or more processors to perform operations comprising identifying at least one object in the images, wherein the at least one object is currency.

8. A non-transitory computer-readable storage medium with program instructions stored thereon, the program instructions when executed by one or more processors are operable to cause the one or more processors to perform operations comprising:
capturing, by one or more cameras coupled to one or more earbuds, images of an environment of a user while the user is wearing the one or more earbuds;
converting data associated with the images to audio; and
providing, by the one or more earbuds, the audio to the user.

9. The computer-readable storage medium of claim 8, wherein the one or more earbuds comprise a central body and one or more posts, and wherein one or more lenses of the one or more cameras are coupled to the central body or the one or more posts of the one or more earbuds.

10. The computer-readable storage medium of claim 8, wherein the instructions when executed are further operable to cause the one or more processors to perform operations comprising:
identifying at least one object in the images;
accessing a memory that stores data associated with the at least one object;
converting at least one portion of the data to audio; and
providing, by the one or more earbuds, the at least one portion of the data to the user.

11. The computer-readable storage medium of claim 8, wherein the instructions when executed are further operable to cause the one or more processors to perform operations comprising:
identifying at least one object in the images, wherein the at least one object is a person;
accessing a memory that stores data associated with the person;
converting at least one portion of the data to audio; and
providing, by the one or more earbuds, the at least one portion of the data to the user, wherein the at least one portion of the data comprises at least a name of the person.

12. The computer-readable storage medium of claim 8, wherein the instructions when executed are further operable to cause the one or more processors to perform operations comprising:
identifying at least one object in the images;
computing a location of at least one object;
converting data associated with an identification and a location of the at least one object to audio; and
providing, by the one or more earbuds, the identification and the location of the at least one object to a user.

13. The computer-readable storage medium of claim 8, wherein the instructions when executed are further operable to cause the one or more processors to perform operations comprising identifying at least one object in the images, wherein the at least one object is a health hazard.

14. The computer-readable storage medium of claim 8, wherein the instructions when executed are further operable to cause the one or more processors to perform operations comprising identifying at least one object in the images, wherein the at least one object is currency.

15. A computer-implemented method comprising:
capturing, by one or more cameras coupled to one or more earbuds, images of an environment of a user while the user is wearing the one or more earbuds;
converting data associated with the images to audio; and
providing, by the one or more earbuds, the audio to the user.

16. The method of claim 15, wherein the one or more earbuds comprise a central body and one or more posts, and wherein one or more lenses of the one or more cameras are coupled to the central body or the one or more posts of the one or more earbuds.

17. The method of claim 15, further comprising:
identifying at least one object in the images;
accessing a memory that stores data associated with the at least one object;
converting at least one portion of the data to audio; and
providing, by the one or more earbuds, the at least one portion of the data to the user.

18. The method of claim 15, further comprising:
identifying at least one object in the images, wherein the at least one object is a person;
accessing a memory that stores data associated with the person;
converting at least one portion of the data to audio; and
providing, by the one or more earbuds, the at least one portion of the data to the user, wherein the at least one portion of the data comprises at least a name of the person.

19. The method of claim 15, further comprising:
identifying at least one object in the images;
computing a location of at least one object;
converting data associated with an identification and a location of the at least one object to audio; and
providing, by the one or more earbuds, the identification and the location of the at least one object to a user.

20. The method of claim 15. further comprising identifying at least one object in the images, wherein the at least one object is a health hazard.
